(19) United States
(12) Patent Application Publication
(10) Pub. No.: US 2025/0200736 A1
(43) Pub. Date: Jun. 19, 2025

(54) IMAGE PROCESSING METHODS AND SYSTEMS FOR DETECTING CHANGE IN INFRASTRUCTURE ASSETS

(71) Applicant: San Diego State University Research Foundation, San Diego, CA (US)

(72) Inventors: Andrew C. Loerch, San Diego, CA (US); Douglas A. Stow, San Diego, CA (US); LLoyd L.A. Coulter, San Diego, CA (US)

(21) Appl. No.: 19/067,603

(22) Filed: Feb. 28, 2025

Related U.S. Application Data
(63) Continuation of application No. PCT/US23/73373, filed on Sep. 1, 2023.
(60) Provisional application No. 63/374,543, filed on Sep. 3, 2022.

(51) Int. Cl. G06T 7/00; G06T 7/174; G06T 7/33

(52) U.S. Cl. CPC G06T 7/0002; G06T 7/174; G06T 7/337; G06T 2207/10032; G06T 2207/20021; G06T 2207/20081; G06T 2207/20084; G06T 2207/30184; G06T 2207/30232

(57) ABSTRACT

Devices, systems and methods that are configured to use image processing to detect structural changes in infrastructure assets are described. An example method for identifying damage in an infrastructure asset includes receiving multitemporal image sets including a time-1 image set and a time-n image set that is sequentially later in time than the time-1 image set, performing an image co-registration operation between the multitemporal image sets and images in a repeat station imaging dataset to generate a registered image pair set, segmenting each image of each image pair of the registered image pair set to generate a plurality of paired tiles, and performing, using a recursive neural network, a change detection operation on each of the plurality of paired tiles.

### CROSS-REFERENCE TO RELATED APPLICATION

This patent document is a continuation of International Patent Application No. PCT/US23/73373, entitled “IMAGE PROCESSING METHODS AND SYSTEMS FOR DETECTING CHANGE IN INFRASTRUCTURE ASSETS,” filed on Sep. 1, 2023, which claims the benefits of and the priority from U.S. Provisional Patent Application No. 63/374,543, entitled “IMAGE PROCESSING SOFTWARE FOR UTILITIES,” filed on Sep. 3, 2022, which are incorporated by reference herein in their entireties.

### TECHNICAL FIELD

This document generally relates to monitoring and maintenance of infrastructure assets, and more particularly, to using image surveillance to collect images of infrastructure assets and image processing of collected images to detect changes to the infrastructure assets.

### BACKGROUND

Various public and private infrastructures including electric power transmission lines and towers may be vital part of national and regional economic development for communities. Failure to provide adequate maintenance to existing infrastructure may lead to malfunction or failure of the impacted infrastructure which may result in damages. Costlier repairs and complete rebuilds will eventually become necessary, and the costs trickle down to facility renters. Poor maintenance of infrastructures such as electricity, fiber optics, and buildings themselves may put the burden on facility renters to come up with temporary solutions. Investing in temporary solutions such as backup generators and waste disposal takes away capital that could be used for innovation and for building new infrastructure. Keeping up with infrastructure maintenance is important to public and businesses sectors and enable entities to prolong the operation of existing infrastructure and better focus their resources to new developments and projects rather than cleaning up the past.

### SUMMARY

Embodiments of the disclosed technology relate to methods, systems, and devices for capturing images of infrastructure assets over time, and using image processing to detect change (e.g., damage) in those infrastructure assets. The disclosed embodiments achieve state-of-the-art overall accuracy at the binary classification task of multitemporal image change detection.

In an example aspect, a method for identifying change in an infrastructure asset includes performing an image co-registration operation to spatially align multitemporal image sets including different image sets of digital images of the infrastructure asset captured under identical or nearly identical conditions and sequentially in time with previously captured reference images of the infrastructure asset to generate different registered image sets, pairing two registered image sets corresponding to images captured at two different times to form a registered image pair set, segmenting each image of each image pair of the registered image pair set to generate a plurality of paired tiles, and performing, using a recursive neural network, a change detection operation on each of the plurality of paired tiles to detect a change in the infrastructure asset between two paired tiles for images captured at different times, respectively. In this example, the recursive neural network includes at least one convolution network layer including an input configured to receive the plurality of paired tiles, at least one recurrent network layer including an input coupled to an output of the at least one convolution network layer, a plurality of fully-connected layers including an input coupled to an output of the at least one recurrent network layer, and an output classifier including an input coupled to an output of the plurality of fully-connected layers and an output configured to generate a result of the change detection operation.

In another example aspect, a system for identifying change in an infrastructure asset includes one or more processors, and one or more memories storing instructions that, when executed, cause the one or more processors to receive a multitemporal image pair set including a time-1 image set and a time-n image set that is sequentially later in time than the time-1 image set. Here, each of the time-1 image set and the time-n image set includes a sequence of digital images of the infrastructure asset. The one or more processors are further configured to segment each image of time-1 image set and the time-n image set to generate a plurality of paired tiles, and perform, using a recursive neural network, a change detection operation on each of the plurality of paired tiles to detect a change in the infrastructure asset between a time-1 tile and a time-n tile. In this example, the recursive neural network includes at least one convolution network layer including an input configured to receive the plurality of paired tiles, a plurality of time-distributed convolution filters, a pooling layer, and an output from the pooling layer, at least one recurrent network layer including an input coupled to the output from the pooling layer, a plurality of long short-term memory (LSTM) recurrent network layers, and an output from a last LSTM recurrent network layer, a plurality of fully-connected layers including an input coupled to the output of the last LSTM recurrent network layer and an output from a last fully-connected layer, each fully-connected layer using a rectified linear unit (ReLU) activation function, and an output classifier including an input coupled to the output of the last fully-connected layer and an output configured to generate a result of the change detection operation, the output classifier using a sigmoid activation function.

In yet another example aspect, the above-described method may be implemented by an apparatus or device that includes a processor and/or memory.

In yet another example aspect, this method may be embodied in the form of processor-executable instructions and stored on a computer-readable program medium.

The subject matter described in this patent document can be implemented in specific ways that provide one or more of the following features.

### BRIEF DESCRIPTION OF THE DRAWINGS

FIG. 1 illustrates an example system for identifying change in an infrastructure asset, in accordance with the described embodiments.

FIG. 2 illustrates an example architecture of a recurrent neural network (RNN) used for change detection in the described embodiments.

FIG. 3 illustrates the operation of an example convolutional neural network (CNN).

FIG. 4 illustrates a numerical example of a convolution.

FIG. 5 illustrates an example dataset structure from the RNN.

FIG. 6 illustrates a block diagram of an example unmanned aerial vehicle (UAV).

FIG. 7 is a flowchart of an example method for identifying change in an infrastructure asset, in accordance with the described embodiments.

FIG. 8 is a block diagram illustrating an example system configured to implement embodiments of the disclosed technology.

### DETAILED DESCRIPTION

This patent document discloses examples and implementations of devices, systems, and methods for capturing images of infrastructure assets over time, and using image processing to detect change (e.g., damage, increased wear-and-tear, etc.) in those infrastructure assets to extract actionable information for monitoring and maintenance of infrastructure assets and repairs.

### 1 Introduction

Substantial debate persists within academic research, federal management agencies, and the organizations responsible for managing infrastructure, regarding a common definition of “critical infrastructure.” Although no commonly agreed upon definition of what constitutes specific critical infrastructure features can be found across all domains, the category of critical infrastructure can be summarized as any resource or feature that is necessary for the functioning of society. Built features are generally critical infrastructure when they are any physical component of a vital societal resource that would be hampered or cease functioning without the feature, particularly immediately following a major hazard event. The societal resources making use of critical infrastructure are emergency response, transportation, energy, and governmental. Examples of built features found in these societal resources include government and medical buildings, bridges, roads, railways, airports, and the physical components of an energy grid.

There are currently problems involving detecting damage to infrastructure, such as electric utility towers and poles, buildings, roads, bridges, power plants, transformers, sub-stations, dams, solar arrays, wind-power towers, silos, oil and gas pumping equipment, oil and gas transfer equipment including stations and pipelines, water purification plants, chemical processing plants, mining equipment, aircraft, railroad infrastructure, and communication infrastructures such as wireless communication towers. Damage to these structures can increase fire ignition potential from uninspected or poorly inspected transmission and distribution towers/poles, transportation delays, brown- and black-outs, damage to communities, damage to commodities, damage to the environment, and damage to human health. Current inspections are performed with unmanned aerial systems that blanket a structure with image captures, resulting in hundreds of megabytes to gigabytes of data collected per structure. Additionally, inspectors or automated analysis approaches must evaluate the captured imagery. Accordingly, there are a large number of images that must be potentially viewed by automatically detecting and highlighting locations of structural changes. Human inspections of imagery are time consuming and entirely dependent on the inspectors' skill and focus, increasing the likelihood of missed damage. Current automated inspections of single-date imagery continue have unacceptable accuracy levels, and the existing systems require the need for machine learning to ‘learn’ about every possible component on any structure and what damaged states look like.

Embodiments of the disclosed technology address these and other problems in the art by providing systems and processes that provide for infrastructure inspectors (the intended users) to manage and quickly review potential damage to electric utility towers or poles, buildings, roads, bridges, power plants, transformers, sub-stations, dams, solar arrays, wind-power towers, silos, oil and gas pumping equipment, oil and gas transfer equipment including stations and pipelines, water purification plants, chemical processing plants, mining equipment, aircraft, and rail infrastructure. The systems and processes use software that uses multiple dates of imagery collected with repeat station imaging (a location-based aerial platform navigation and sensor trigging approach), automated image co-registration, and machine learning to identify potential damage and display it to the end user.

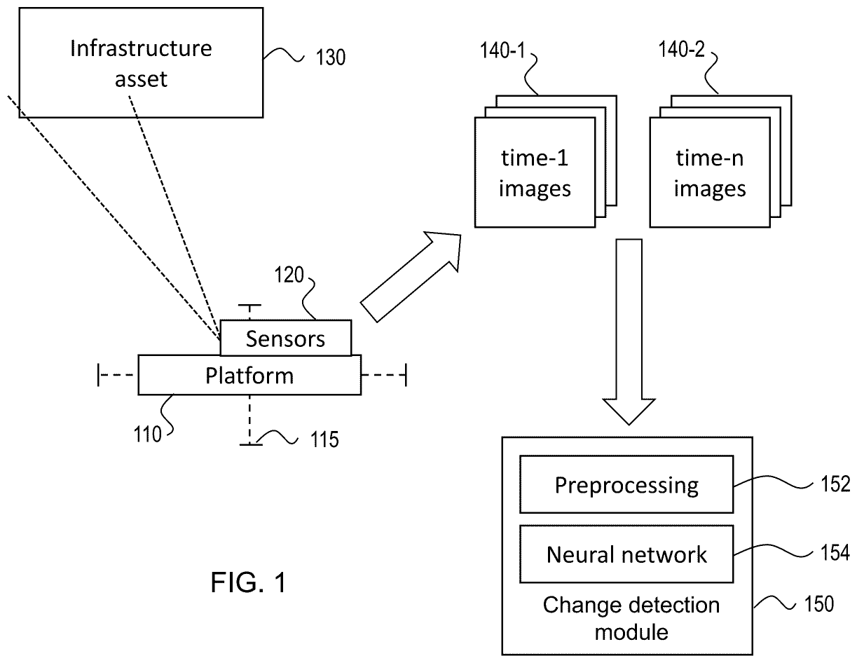

FIG. 1 illustrates an example of an infrastructure system for identifying changes in an infrastructure asset over time based on the disclosed technology. As shown therein, a platform 110 that includes one or more sensors 120 is deployed and positioned to capture images of an infrastructure asset 130, and generate a multitemporal image set 140 including a first series of images captured at a first time (denoted time-1 images 140-1) and a second series of images captured at a second time (denoted time-n images 140-2). The platform 110 captures the first and second series of images from substantially the same position (denoted using error bars 115) but at different times.

In some embodiments, the platform 110 can be an unmanned aerial vehicle (UAV) that is configured and operable to follow a three-dimensional flight plan that positions it in substantially the same position when capturing images of the infrastructure asset 130 using the one or more sensors 120. In other embodiments, the platform 110 can be a piloted aircraft that can be maneuvered to substantially the same position when capturing both sets of images. In yet other embodiments, the platform 110 can be an autonomous or a crewed vehicle (e.g., wheeled, tracked, or water vehicles) for inspect target infrastructure targets.

In some embodiments, the one or more sensors 120 carried by the platform 110 include high-definition cameras, embedded cameras, thermal cameras, infrared (IR) camera sensors, OEM camera cores, and/or camera modules. In an example, the cameras are configured to directly capture images of the infrastructure asset 130. In another example, the cameras are configured to capture a video of the infrastructure asset, and subsequently extract frames from the video.

The captured multitemporal image set 140, which includes the first set of images 140-1 and the second set of images 140-2, is input to a change detection module 150, which includes a preprocessing module 152 and a neural network module 154. The preprocessing module 152 is configured to perform registration on the multitemporal image set (as described in Section 2.3), which is then input to the neural network module 154 that includes, in an example, a recursive neural network (as described in Section 2.1) that is architected to process the registered multitemporal image set, and output whether a change is detected between the time-1 images and the time-n images of the infrastructure asset 130.

In some embodiments, the multitemporal image set 140 includes more than two sets of images of the monitored infrastructure asset captured over different times. For example, the change detection module 150 is configured to processes a first set of images captured at time t₁, a second set of images captured at t₂>t₁, a third set of images captured at time t₃>t₂, and so on. The training and inference stages implemented by the neural network 154 can be configured to process a pair of images from any two times, e.g., t₁ and t₂, t₂ and t₃, t₁ and t₃, and so on, to determine whether a change has occurred.

In the examples described herein, a multitemporal image set includes images collected at predetermined camera locations using navigation and triggering systems that are based on position information from a positioning system. The positioning system can be one or more of a global navigation satellite system (GNSS), e.g., Global Positioning System (GPS), GLONASS, Galileo, or Beidou, a triangulation system based on fixed emitters, e.g., Wi-Fi or cellular (3GPP 5G, 5G NR, 6G, etc.), or an inertial measurement unit (IMU)-based positioning system. For example, and in the context of FIG. 1, the multitemporal image set includes the first set of images 140-1, which is collected at time-1, and the second set of images 140-2, which is collected at time-n, with both sets of images being collected in substantially the same position, e.g., within error bars 115.

The examples of the disclosed technology described herein are directed to a specific implementation of the platform 110: an unmanned aerial vehicle (UAV), but the techniques disclosed in the present document are not limited to using a UAV, and can be implemented with other platforms and sensors, as described herein.

In some embodiments, the change detection module 150 is communicatively coupled to a graphical user interface (not shown in FIG. 1), which is designed to display co-aligned multitemporal image pairs and results of automated change detection efficiently and graphically. This display capability is initiated and accomplished by selecting individual camera stations that contain multitemporal, repeat station imaging (RSI) image pairs. Selection of the individual camera stations may be accomplished using a camera station pick list, or interactively using graphical map representations of the camera stations in two-dimensional or three-dimensional map viewers.

The described features can be implemented in a specific application to provide, inter alia, one or more the following benefits or advantages:
Addressing the problem of increased fire ignition potential from uninspected or poorly inspected transmission and distribution towers/poles by increasing the frequency of infrastructure inspections, and improving the quality and efficiency of the inspections.
Addressing the problem of massive over-collection of image captures by reducing the number of images that must be potentially viewed by automatically detecting and highlighting locations of structural changes, and reducing the time required to find damage in imagery and presenting it for each structure in an efficient, easy to use manner.
Providing a machine learning component that highlights areas in multitemporal image pairs for each structure that may be damaged and require additional attention.
Improving accuracy levels by using a multitemporal approach to eliminate the need for machine learning to ‘learn’ about every possible component on any structure and what damaged states look like, and instead learns to distinguish between real change and/or damage versus background noise.
Providing a specifically designed graphical user interface for inspections of utility infrastructure, which is not the case of other software that handles images, co-registration, GIS, etc. The advantages are inspection efficiency and accuracy and image data management.
Providing multitemporal machine learning that uses artificial intelligence models designed for multitemporal co-registered images, which is very different from extant software. The advantage is in increased inspection accuracy and timeliness.

### 2 Implementation of an Example Recurrent Neural Network (RNN)

Recurrent neural networks (RNNs) are a type of artificial neural network designed to process sequences of data in time by associating the current input and output of a RNN with information from prior inputs to the RNNs. Example of some early applications of RNNs were in natural language and signal processing. Given a sequence of data inputs, an RNN learns patterns to infer the next sequence. The basic recurrent network cell includes input values and labels, and an operation that finds the standard deviation of the weights and biases against those inputs over time. The ability of an RNN to learn the spectral-radiometric, spatial, and temporal properties of features makes them attractive options for image change detection.

### 2.1 Architecture of the Example RNN

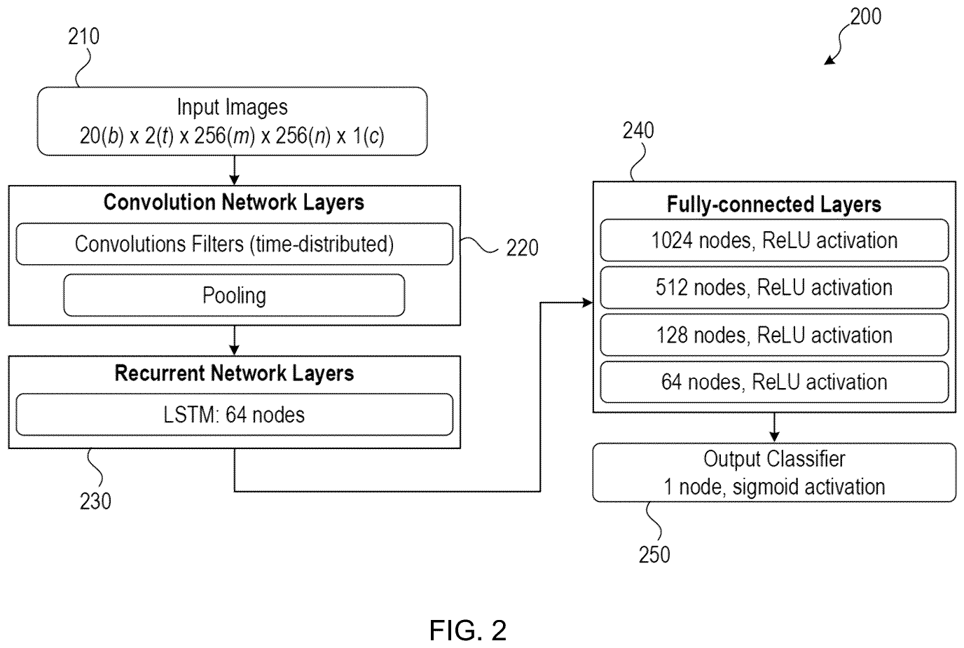

The architecture of the RNN 200, in FIG. 2, uses co-registered multitemporal images 210 that are first passed through convolution network layers 220. The output of the convolution network layers 220 is passed to recurrent network layers 230, followed by multiple fully-connected layers 240. The output of the multiple fully-connected layers 140 is finally passed to an output classifier 250.

The convolution network layers 220 include convolution filters and a pooling layer. In contrast to the traditional CNN, the convolution filters of RNN 200 separately operate on two images (time-1, time-n) with one channel each (further described in Section 2.3), and use a time-distributed convolution, which enables long short-term memory nodes to be used in the recurrent network layers 230. In some embodiments, the convolution filters in the convolution network layers 220 use a ReLU activation function.

In some embodiments, the number of convolutional layers 220 and LSTM nodes 230 (or more generally, LSTM network 230) are determined through empirical tests of models of various complexity. These tests compare the models' accuracies and losses during training and validation. The chosen model complexity (e.g., as described in Section 2.4) reflects the point at which additional layers and nodes failed to yield substantial accuracy gains.

Long short-term memory (LSTM) nodes address an issue with a basic RNN, where the RNN's predictions become less accurate as time (the number of data sequences) increases. It accomplishes this by introducing a ‘forget gate’, ‘input gate’, and an ‘output gate’. Input data enters the ‘forget gate’ first, and the cell determines whether to ‘keep’ or ‘forget’ the data. The ‘input gate’ component determines what data can be saved in the LSTM node, and the ‘output gate’ determines the node's data output. This process of forgetting and determining the data the node should store makes RNNs with LSTM more robust than basic RNNs over time.

However, LSTM networks have certain limitations, which includes computational complexity and sensitivity to hyperparameters. With regard to the former, LSTM networks are computationally intensive compared to feedforward neural networks. This is primarily due to the recurrent nature of LSTM, where the hidden state needs to be propagated through time steps. As the sequence length increases, the computational cost grows linearly with respect to the number of time steps. And with regard to the latter limitation, LSTM networks have several hyperparameters that need to be tuned, such as the number of memory cells, the learning rate, and regularization parameters. Finding an optimal set of hyperparameters can be a challenging and time-consuming process. Poorly chosen hyperparameters may lead to suboptimal performance or difficulties in training the network effectively.

In the described embodiments, the input to the LSTM nodes is multitemporal images, i.e., two-dimensional visual imagery over a temporal dimension. Due to the limitations of LSTM networks described above, an LSTM network that processes a three-dimensional input cannot be designed by simply reconfiguring an LSTM network that processes an input with a lower number of dimensions, e.g., an LSTM that processes a one-dimensional input (e.g., a time-series) cannot be straightforwardly repurposed to process two- or three-dimensional input data.

In some embodiments, the RNN 200 computes weights for the image sequence and saves them in the LSTM nodes. Herein, each of the multiple fully-connected layers 240 uses a ReLU activation function, and the output classifier 250 uses a sigmoid activation function.

### 2.2. Architecture of an Example CNN

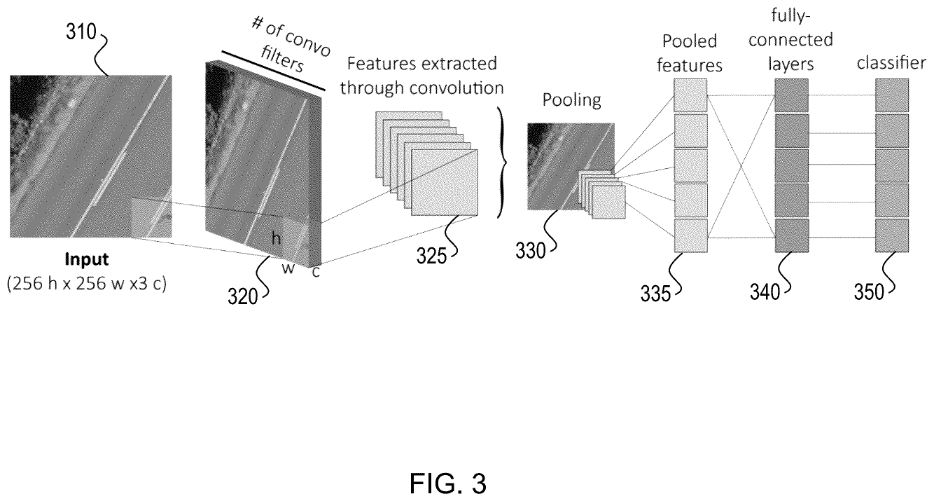

The example RNN 200 designed for change detection of multitemporal imagery in FIG. 2 can leverage components of a convolutional neural network (CNN) that is illustrated in FIG. 3 as further described blow.

The structure of the CNN shown in FIG. 3 includes an input image 310, multiple blocks of convolution filters 320 and pooling layers 330, fully-connected layers 340, and the output classifier 350. As shown therein, the convolution filters 320 learn to identify and extract features 325 and are passed to the pooling layer 330 for dimension reduction. The pooled features 335 are passed to the fully-connected layers 340, which separate and pass the features to the output classifier 350.

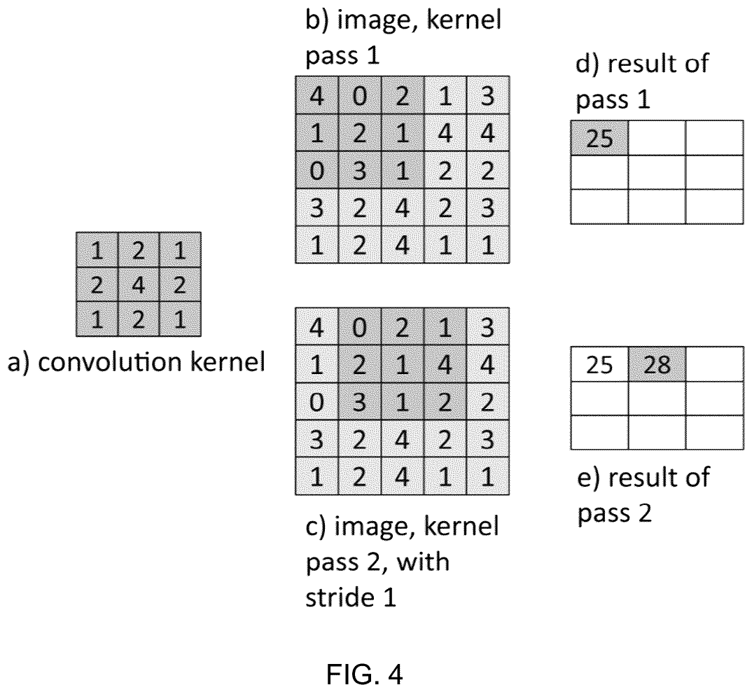

The input to a CNN can be of any size (rows (m) x columns (n)) and dimension (color channels (c)). Convolution layers in the feature extraction process are designed to learn the spatial and spectral representations of the image classes. The initial layer of convolution kernels will accept an input data shape equal to (m x n x c). Subsequent convolution and fully-connected layers are designed to accept input shapes equal to the output shapes of their previous layer. FIG. 4 shows a numerical example of the convolution process. In a CNN, and as shown in FIG. 4, the values in (a) are the weights learned by the model. Both (b) and (c) demonstrate how the kernel moves along an image, and both (d) and (e) show the new pixel values of the output image as the kernel moves.

Activation functions are arithmetic operations that generate the outputs of each convolution, fully-connected, and classification layer in a CNN. Three commonly used activation functions include rectified linear unit (ReLU), hyperbolic tangent, and sigmoid. The ReLU activation evaluates values generated by the input data and weights in a node, and outputs the values if they are greater than zero; the node's output is zero if the values are less than or equal to zero. This function is useful for binary and non-binary classification problems as its output range can match the input data and it does not approach a limit of one or zero (the vanishing gradient problem). The hyperbolic tangent function evaluates the input data and weights and outputs values of −1 to 1, while the sigmoid function outputs values from 0 to 1. Both the hyperbolic tangent and sigmoid functions are useful in binary classification problems and RNNs can be configured to make use of the hyperbolic tangent activation function.

A layer with pooling nodes takes the spatial/spectral features found (i.e., examples of classes) during convolution and decreases their height and width dimensions. This is achieved by replacing the pixel values in a moving matrix (kernel) of some height and width with the maximum pixel value. The number of columns and rows the kernel moves before its next operation is referred to as the stride; for image reduction the stride is equal to the kernel size. For example, a 20 pixel by 20 pixel image could be reduced with a maximum value kernel of 2 by 2 pixels, and a stride of 2, to a new image of size 10 pixels by 10 pixels. The equation below shows how the reduction in image size is calculated with a pooling node of a given size. Pooling layers are used to reduce the number of parameters needed by a model to represent a feature.

$${h}_{o} = \frac{( h - {K}_{h} )}{{s}_{h}} + 1 , {w}_{o} = \frac{( w - {K}_{w} )}{{s}_{w}} + 1$$

In the equation above, h and w are the height and width of the image, respectively, Kₕ and K_{w} are the height and width of the kernel, respectively, sₕ is the row stride, s_{w} is the column stride, and h, and we are the height and width of the output, respectively.

The fully-connected layers take the output pixel values from convolution nodes as inputs, perform a classification function (the activation function described above) on the values, and compare the predictions with the image label. The degree of error between the classification prediction and the label is measured as “loss.” A CNN uses this loss metric to move backwards through the layers and determine whether the model weights' values should be increased or decreased in a process called back-propagation.

### 2.3 Preprocessing and Training for the Example RNN

In some implementations of the RNN 200 in FIG. 2, the input images 210 to the example RNN 200 are captured from a constant vantage point across time. In an example, one or more image sensors on an unmanned aerial vehicle (UAV) capture the input images 210. Prior to using the RNN 200 in the inference mode, i.e., to detect structural changes in an infrastructure asset, images that are similar to input images 210 are used to train the RNN 200, as well as to generate a repeat station imaging (RSI) dataset of captured reference images of the infrastructure target.

Repeat station imaging (RSI) is a method for acquiring images of the infrastructure target as reference images for use in change detection, and uses pre-planned flight paths designed with global navigation satellite system (GNSS) waypoints (i.e., x-y-z positions programmed for UAS flight navigation) to navigate an image sensing platform to the same position over time, and the imaging sensor is triggered at camera stations with specified angles based on these waypoints to capture images repeatedly at different times. Such reference images are subsequently used in an image registration in processing captured images for the change detection at different times. This image registration spatially aligns two or more image datasets of the same scene taken at different times, from different viewpoints, and/or by different sensors and can be used to detect differences between spatially aligned image datasets. Provided the same sensor is used across the different image acquisitions, the result is “multitemporal imagery with matched view geometry,” such that geometric alignment (or co-registration) between multitemporal images is simplified, rapid, and near pixel-level spatial accuracy. The RSI dataset is the set of reference images that were previously captured using this method, and subsequently registered with respect to later captured images for the change detection. Additional details for RSI can be found in (1) U.S. Pat. No. 9,756,293 B2 entitled “Systems, methods and devices for repeat pass imaging for wide area intermittent video” and by inventors Lloyd Lawrence Arthur Coulter and Christopher Lippitt; (2) “A Frame Center Matching Technique for Precise Registration of Multitemporal Airborne Frame Imagery” by Coulter, L. L.; Stow, D. A.; Baer, S. in IEEE Trans. Geosci. Remote Sens. 2003, 41, 2436-2444; (3) “Remote Sensing Theory and Time-Sensitive Information” by Lippitt, C. D.; Stow, D. A. in “Time-Sensitive Remote Sensing” by Springer: Berlin/Heidelberg, Germany, pp. 1-10 (2015); (4) “Comparing the Accuracy of SUAS Navigation, Image Co-Registration and CNN-Based Damage Detection between Traditional and Repeat Station Imaging” by Loerch, Andrew C., Douglas A. Stow, Lloyd L. Coulter, Atsushi Nara, and James Frew in Geosciences 12, no. 11:401 (2022), which are incorporated, in their entirety, as part of this document.

The preprocessing for the example RNN 200 includes co-registering the input images 210 with the RSI dataset, and then partitioning (or segmenting) the single-channel time-1 and time-n images into equally-sized tiles. Processing the tiles, instead of the entire image, ensures that the computational complexity of the change detection algorithm is feasible. In an example, the size of the tiles is configured based on a complexity of a processor core implementing the recursive neural network (e.g., access to increased computational power typically results in using larger tiles), a size of the change in the infrastructure asset (e.g., a single tile should typically span the change that is being detected), or a resolution of the multitemporal image sets (e.g., higher resolution images will typically use smaller tiles).

As discussed above, the preprocessing includes registration of the input images with the RSI dataset. Misregistration within multitemporal image datasets ultimately results in a greater number of falsely detected changes and identification of fewer actual changes, degrading the change detection results.

In some embodiments, the co-registration in the preprocessing stage can be implemented to include coarse pre-registration (e.g., not at the pixel level) because the architecture of the RNN compensates for imperfect registration. Using coarse pre-registration advantageously reduces the computational complexity of the overall system. For example, using the RSI image collection approach described herein and assuming the UAV can consistently collect images from within 20 cm of the specified location, image co-registration accuracy for oblique images achieved 5.5 pixels RMSE (root-mean-squared error). The RNN easily compensates for this misregistration, where traditional change detection and analysis techniques would erroneously identify the misregistration as change.

In some embodiments, the example RNN 200 is trained using sequences of spatially corresponding time-1 and time-n tiles of size 2 (t, times)×N (m, rows)×N (n, columns)×1 (c, image bands), e.g., N=256, which are split into two sets with an equal number of tiles in each set. One set of tiles includes simulated damage in the time-n tiles, and the other set of tiles are damage-free. A single label is applied to each sequence of tiles: ‘1’ for damage, and ‘0’ for no damage. The time-1 and time-n tiles are treated as image sequences, similar to image frames in a stationary-mounted, fixed viewing angle video.

In an example, the simulated damage includes a crack in the infrastructure asset. To automatically generate the cracks for the one set of tiles with N=256, the following parameters were randomly selected from the specified ranges:
a region size ranging from 24×24 pixels to 128×128 pixels;
a number of cracks, within the region, ranging from 1 to 10;
a width of the crack ranging from 1 pixel to 2 pixels;
a length of the crack ranging from 4 pixels to the region size;
a starting location of the crack anywhere in the region; and
a brightness value of the crack ranging from 0% to 20% of the available brightness range (e.g., 0-50).

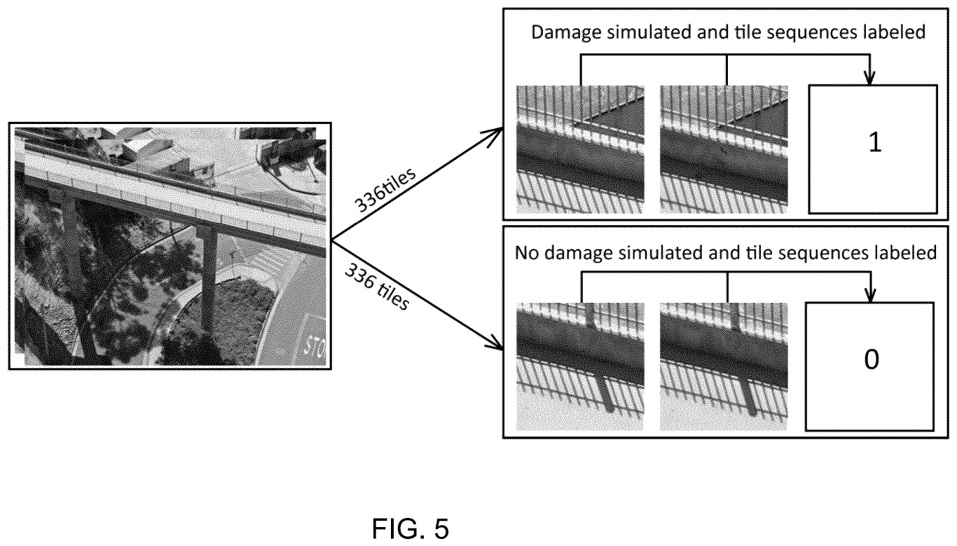

Furthermore, a Gaussian smoothing function was applied to 80% of the cracks generated. FIG. 5 shows an example of generating tiles, from an image captured by a single camera station, for training the example RNN 200.

In some embodiments, the preprocessing operation includes bulk image transformations, automatic co-registration of image pairs based on geographic proximity, and the selection of parameters for the RNN model for damage detection.

### 2.4 Numerical Results for the Example RNN

In an example implementation, the repeat station imaging (RSI) datasets were collected with two different drones in three different scenarios, e.g., the DJI M300 using real-time-kinematic (RTK) navigation, which had the lowest mean absolute error (MAE) for co-registration of time-n image pairs (2.3 pixels MAE) versus the DJI M300 without RTK (5.0 pixels MAE) and the DJI Mavic 1 without RTK (139.2 pixels MAE).

The following results used the dataset with the lowest co-registration MAE (2.3 pixels) (DJI M300 with RTK) as the input to the RNN, and the dataset structure and damage simulation method were modified to fit the input requirements for the RNN learning process.

RNN training was performed with time-1 and time-n image pairs and a batch size of 20 pairs (40 images). During training, a selection of 30% of the DJI M300 RTK dataset image pairs was set aside and used exclusively for validation accuracy. The training was stopped at 60 epochs. The detection accuracy of the RNN was evaluated by feeding the models selected images of bridges, buildings, and roads that were not used in model training and validation. Because the simulated damage generation was automated and the tiles in an image were predicted by the models to contain either new time-n cracks or not, a direct cross-tabulation of the predictions and labels was possible.

Table 1 shows the cross-tabulation results, user's, producer's, and overall accuracy for post-event crack damage detection using the RNN configured in accordance with the disclosed technology. The mean overall accuracy of the RNN was 98.3%, with the user's and producer's accuracies for the ‘damage’ class being lower than for the ‘no damage’ class across all features, ranging from 93.0% to 97.6%. The cross-tabulation results are for 2 classes: no damage and damage, and the results are presented by primary feature types: bridges, buildings, roads.

TABLE 1
RNN cross-tabulation confusion matrix

| | Bridges | | | Buildings | | | Roads | | |
|---|---|---|---|---|---|---|---|---|---|
| | No | | User's | No | | User's | No | | User's |
| | Damage | Damage | Accuracy | Damage | Damage | Accuracy | Damage | Damage | Accuracy |
| No Damage | 4309 | 41 | 99.1% | 5154 | 81 | 98.5% | 4027 | 39 | 99.0% |
| (Reference) | | | | | | | | | |
| Damage | 47 | 979 | 95.4% | 63 | 1758 | 96.5% | 31 | 1279 | 97.6% |
| (Reference) | | | | | | | | | |
| Producer's | 98.9% | 96.0% | | 98.8% | 95.6% | | 99.2% | 97.0% | |
| Accuracy | | | | | | | | | |
| Overall | | | 98.4% | | | 98.0% | | | 98.7% |
| Accuracy | | | | | | | | | |

The data volumes and processing rates for the different components and stages of the RNN are shown in Table 2. Therein, the processing times for the loading, training, evaluation and exporting of the images and information products were recorded in hundredths of a second, and were normalized by seconds per megabyte (s/Mb) of data.

TABLE 2
Data volume and processing rates for different RNN components

| | |
|---|---|
| Training: data volume per step (Mb) | 112.81 |
| Training: average data loading rate (s/Mb) | 0.38 |
| Training: average training rate per step (s/Mb) | 0.36 |
| Training: average total training rate (s/Mb) | 7.96 |
| Evaluation: data volume (Mb) | 478.47 |
| Evaluation: average damage detection rate s/Mb) | 0.12 |
| Evaluation: information export rate (s/Mb) | 0.50 |

### 3 Example Methods and Implementations of the Disclosed Technology

In some embodiments, the disclosed technology can be used to detect damage from earthquakes. Manifestations of damage of critical infrastructure that could result following earthquakes are taken from a review of several damage indices and observations of damage from remote sensing systems. These built feature and damage associations are:
Buildings: subsidence, tilt, general structural damage, and collapse, resulting from cracking of walls and foundations and the liquefaction of soil;
Electrical grids: failures resulting from damaged buildings, tilting or toppled utility poles and towers;
Roads: severe cracking from shifting, faulting, and/or liquefied soil, debris from collapsed buildings and landslides; and
Bridges: surface cracking, tilting, or collapse from movement of support structures during the shaking and/or liquefaction of soil around pylons.

In some embodiments, the disclosed technology can be used in the electric utility industry, wherein RNN is configured to focus on the identification of specific damage types to specific structural components rather than change detection from regular structure monitoring.

More generally, the described embodiments can be deployed for the detection of damage from wear over time, severe weather events, wildfires, earthquakes, tornadoes, hurricanes, storm surge, floods, etc. to an electric utility tower or pole, building, road, bridge, power plant, transformer, sub-station, dam, solar array, wind-power tower, silo, oil and gas pumping equipment, oil and gas transfer equipment including station and pipeline, water purification plant, chemical processing plant, mining equipment, aircraft, and rail infrastructure.

In some embodiments, any type of UAV may be used to capture the images of the infrastructure asset. For example, a fixed wing airplane, helicopter, a multi-rotor vehicle (e.g., a quad-copter in single propeller and coaxial configurations), a vertical take-off and landing vehicle, lighter than air aircraft. A multi-rotor vehicle in a coaxial configuration may use the same propeller pitch and diameter propellers, use different pitch and diameter propellers, or variable pitch propellers. Furthermore, UAVs used to implement the disclosed technology include drones, un-operated aerial vehicles, remotely operated aircraft, unmanned aircraft systems, any aircraft covered under Circular 328 AN/190 classified by the International Civil Aviation Organization, and so on.

In some embodiments, other unmanned vehicles (e.g., wheeled, tracked, and/or water vehicles) may be deployed to monitor certain infrastructure assets.

In some embodiments, the sensors deployed on the UAV or other unmanned vehicles include any device that captures real-world information, including cameras, radiation measuring instruments, distance detectors such as Lidar, and so on.

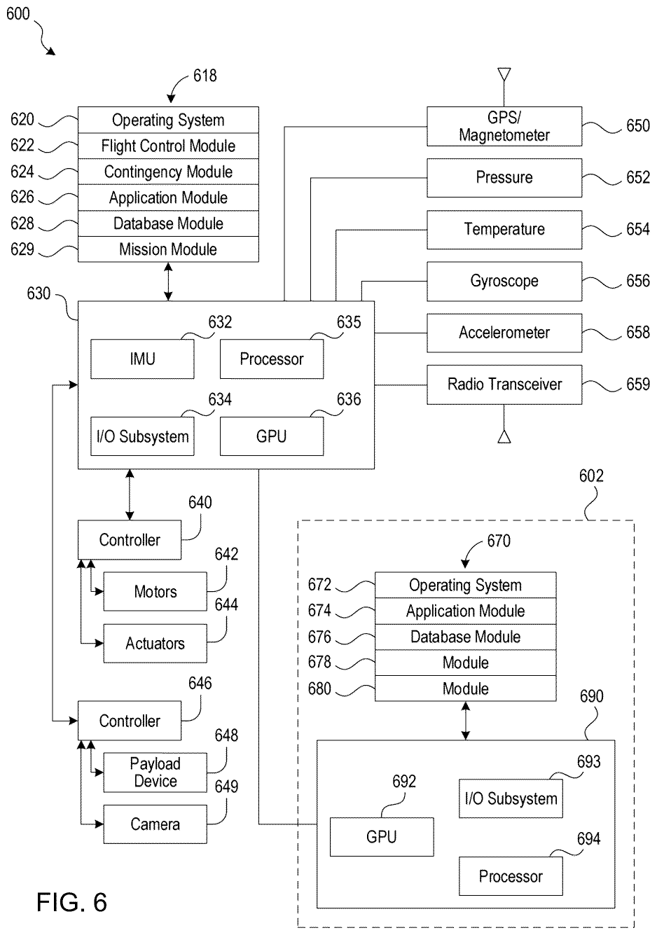

FIG. 6 shows a UAV primary processing system that can be a system of one or more computers, or software executing on a system of one or more computers, which is in communication with, or maintains, one or more databases. The UAV primary processing system 600 can be a system of one or more processors 635, graphics processors 636, I/O subsystem 634, logic circuits, analog circuits, associated volatile and/or non-volatile memory, associated input/output data ports, power ports, etc., and/or one or more software processing executing one or more processors or computers. Memory 618 may include non-volatile memory, such as one or more magnetic disk storage devices, solid state hard drives, or flash memory. Other volatile memory such a RAM, DRAM, SRAM may be used for temporary storage of data while the UAV is operational. Databases may store information describing UAV flight operations, flight plans, contingency events, geofence information, component information, and other information.

The UAV processing system may be coupled to one or more sensors, such as GPS receivers 650, gyroscopes 656, accelerometers 658, pressure sensors (static or differential) 652, current sensors, voltage sensors, magnetometer, hydrometer, and motor sensors. The UAV may use an inertial measurement unit (IMU) 632 for use in navigation of the UAV. Sensors can be coupled to the processing system, or to controller boards coupled to the UAV processing system. One or more communication buses, such as a CAN bus, or signal lines, may couple the various sensor and components.

Various sensors, devices, firmware and other systems may be interconnected to support multiple functions and operations of the UAV. For example, the UAV primary processing system 600 may use various sensors to determine the vehicle's current geo-spatial location, attitude, altitude, velocity, direction, pitch, roll, yaw and/or airspeed and to pilot the vehicle along a specified route and/or to a specified location and/or to control the vehicle's attitude, velocity, altitude, and/or airspeed (optionally even when not navigating the vehicle along a specific path or to a specific location).

The flight control module 622 handles flight control operations of the UAV. The module interacts with one or more controllers 640 that control operation of motors 642 and/or actuators 644. For example, the motors may be used for rotation of propellers, and the actuators may be used for flight surface control such as ailerons, rudders, flaps, landing gear, and parachute deployment.

The contingency module 624 monitors and handles contingency events. For example, the contingency module may detect that the UAV has crossed a border of a geofence, and then instruct the flight control module to return to a predetermined landing location. Other contingency criteria may be the detection of a low battery or fuel state, or malfunctioning of an onboard sensor, motor, or a deviation from the flight plan. The foregoing is not meant to be limiting, as other contingency events may be detected. In some instances, if equipped on the UAV, a parachute may be deployed if the motors or actuators fail.

The mission module 629 processes the flight plan, waypoints, and other associated information with the flight plan as provided to the UAV in the flight package. The mission module 629 works in conjunction with the flight control module. For example, the mission module may send information concerning the flight plan to the flight control module, for example latitude/longitude waypoints, altitude, flight velocity, so that the flight control module can autopilot the UAV.

The UAV may have various devices connected to it for data collection. For example, photographic camera 649, video cameras, infra-red camera, multispectral camera, and Lidar, radio transceiver, sonar, TCAS (traffic collision avoidance system). Data collected by the devices may be stored on the device collecting the data, or the data may be stored on non-volatile memory 618 of the UAV processing system 600.

The UAV processing system 600 may be coupled to various radios, and transmitters 659 for manual control of the UAV, and for wireless or wired data transmission to and from the UAV primary processing system 600, and optionally the UAV secondary processing system 602. The UAV may use one or more communications subsystems, such as a wireless communication or wired subsystem, to facilitate communication to and from the UAV. Wireless communication subsystems may include radio transceivers, and infrared, optical ultrasonic, electromagnetic devices. Wired communication systems may include ports such as Ethernet, USB ports, serial ports, or other types of port to establish a wired connection to the UAV with other devices, such as a ground control system, flight planning system, or other devices, for example a mobile phone, tablet, personal computer, display monitor, other network-enabled devices. The UAV may use a light-weight tethered wire to a ground control station for communication with the UAV. The tethered wire may be removably affixed to the UAV, for example via a magnetic coupler.

Flight data logs may be generated by reading various information from the UAV sensors and operating system and storing the information in non-volatile memory. The data logs may include a combination of various data, such as time, altitude, heading, ambient temperature, processor temperatures, pressure, battery level, fuel level, absolute or relative position, GPS coordinates, pitch, roll, yaw, ground speed, humidity level, velocity, acceleration, contingency information. This foregoing is not meant to be limiting, and other data may be captured and stored in the flight data logs. The flight data logs may be stored on a removable media and the media installed onto the ground control system. Alternatively, the data logs may be wirelessly transmitted to the ground control system or to the flight planning system.

Modules, programs or instructions for performing flight operations, contingency maneuvers, and other functions may be performed with the operating system. In some implementations, the operating system 620 can be a real time operating system (RTOS), UNIX, LINUX, OS X, WINDOWS, ANDROID or other suitable operating system. Additionally, other software modules and applications may run on the operating system, such as a flight control module 622, contingency module 624, application module 626, and database module 628. Typically flight critical functions will be performed using the UAV processing system 600. Operating system 620 may include instructions for handling basic system services and for performing hardware dependent tasks.

In addition to the UAV primary processing system 600, a secondary processing system 602 may be used to run another operating system to perform other functions. A UAV secondary processing system 602 can be a system of one or more computers, or software executing on a system of one or more computers, which is in communication with, or maintains, one or more databases. The UAV secondary processing system 602 can be a system of one or more processors 694, graphics processors 692, I/O subsystem 694 logic circuits, analog circuits, associated volatile and/or non-volatile memory, associated input/output data ports, power ports, etc., and/or one or more software processing executing one or more processors or computers. Memory 670 may include non-volatile memory, such as one or more magnetic disk storage devices, solid state hard drives, flash memory. Other volatile memory such a RAM, DRAM, SRAM may be used for storage of data while the UAV is operational.

In various implementations, modules, applications and other functions running on the secondary processing system 602 may be non-critical functions in nature so that, if the function fails, the UAV will still be able to safely operate. In some implementations, the operating system 672 can be based on real time operating system (RTOS), UNIX, LINUX, OS X, WINDOWS, ANDROID or other operating system. Additionally, other software modules and applications may run on the operating system 672, such as an application module 674, database module 676. Operating system 602 may include instructions for handling basic system services and for performing hardware dependent tasks.

Also, controllers 646 may be used to interact and operate a payload device 648, and other devices such as photographic camera 649, video camera, infra-red camera, multispectral camera, stereo camera pair, Lidar, radio transceiver, sonar, laser ranger, altimeter, TCAS (traffic collision avoidance system), ADS-B (automatic dependent surveillance-broadcast) transponder. Optionally, the secondary processing system 602 may have coupled controllers to control payload devices.

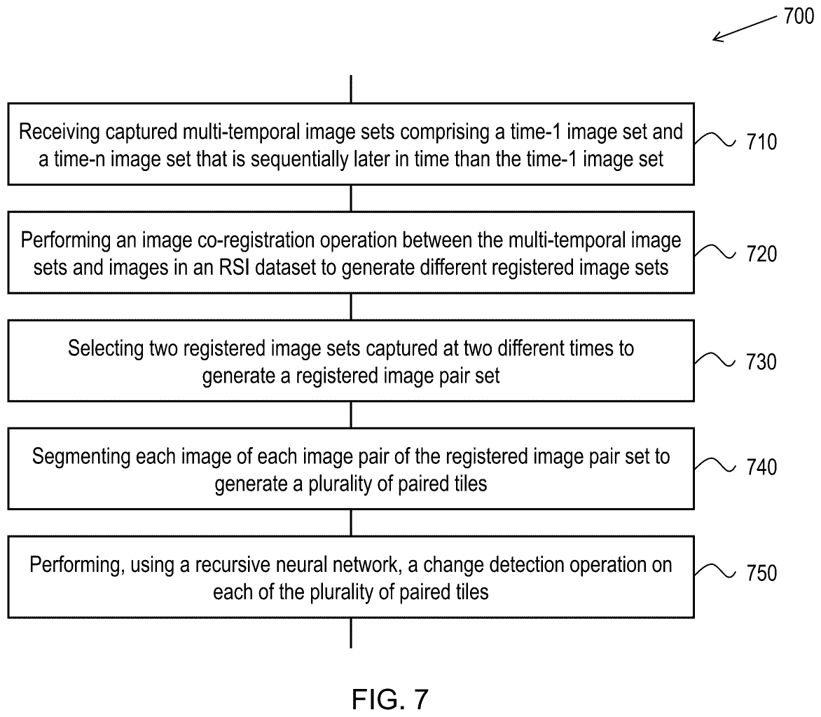

FIG. 7 shows a flowchart of an example method for identifying one or more changes in an infrastructure asset under the imaging surveillance based on the disclosed technology. The method 700 includes, at operation 710, receiving or retrieving captured multitemporal image sets of the infrastructure asset at different times which may include, for example, a time-1 image set captured at time t₁, and at least one more time-n image set that is captured at time tn later in time than the time-1 image set. In some embodiments, each of the time-1 image set and the time-n image set includes a sequence of digital images of the infrastructure asset or/and digital images captured by different cameras to provide different views of the infrastructure asset. In an example, the images are captured using a UAV or other unmanned vehicles.

Alternatively, at operation 710, the method 700 includes receiving multitemporal image sets including a time-1 image set and one or more time-n image sets that are captured sequentially later in time than the time-1 image set. In an example, the one or more time-n image sets include a time-2 image set captured at time t₂ later than t₁, a time-3 image set captured at time t₃ later than t₂, and so on. The time lapse between capturing consecutive image sets may be the same or different.

Alternatively, or additionally, at operation 710, the method 700 includes performing an image co-registration operation to spatially align multitemporal image sets comprising different image sets of digital images of the infrastructure asset captured under identical or nearly identical conditions and sequentially in time with previously captured reference images of the infrastructure asset to generate different registered image sets.

The method 700 includes, at operation 720, performing an image co-registration operation between the multitemporal image sets and images in an RSI dataset to generate a registered image set. Herein, the registered image set is based on (1) a multitemporal image set, (2) images in an RSI dataset, and (3) image registration between (1) and (2). Accordingly, two or more different registered image sets are generated from the multitemporal image sets corresponding to image capture at different times. E.g., operation 720 includes pairing two registered image sets corresponding to images captured at two different times to form a registered image pair set.

Next at operation 730, two registered image sets for images captured at two different times (e.g., time-1 and time-n) are selected for detecting a change at the infrastructure asset occurred between the two different times of the image capture to form a registered image pair set for further processing to detect the change. In an example, if only two multitemporal image sets are registered with the RSI dataset (e.g., at time-1 and time-n), then the selection operation defaults to selecting those two multitemporal image sets. In another example, if multiple multitemporal image sets are registered with the RSI dataset (e.g., at time-1, time-2, time-3, and so on), any pair of the multiple multitemporal image sets are selected.

The method 700 includes, at operation 740, segmenting each image of each image pair of the registered image pair set to generate a plurality of paired tiles. Segmenting the images into tiles is described, for example, in Section 2.3.

The method 700 includes, at operation 750, performing, using a recursive neural network, a change detection operation on each of the plurality of paired tiles.

In some embodiments, the RNN in method 700 includes at least one convolution network layer including an input configured to receive the plurality of paired tiles, at least one recurrent network layer including an input coupled to an output of the at least one convolution network layer, a plurality of fully-connected layers including an input coupled to an output of the at least one recurrent network layer, and an output classifier including an input coupled to an output of the plurality of fully-connected layers and an output configured to generate a result of the change detection operation.

In other embodiments, the RNN in method 700 includes at least one convolution network layer including an input configured to receive the plurality of paired tiles, a plurality of time-distributed convolution filters, a pooling layer, and an output from the pooling layer, at least one recurrent network layer including an input coupled to the output from the pooling layer, a plurality of long short-term memory (LSTM) recurrent network layers, and an output from a last LSTM recurrent network layer, a plurality of fully-connected layers including an input coupled to the output of the last LSTM recurrent network layer and an output from a last fully-connected layer, each fully-connected layer using a rectified linear unit (ReLU) activation function, and an output classifier including an input coupled to the output of the last fully-connected layer and an output configured to generate a result of the change detection operation, the output classifier using a sigmoid activation function.

In some embodiments, the multitemporal image sets comprising different image sets of digital images of the infrastructure asset captured under identical or nearly identical conditions and sequentially in time are captured by using one or more image sensors on a moving platform, wherein a first location of the moving platform when capturing a first image set and a second location of the moving platform when capturing a second image set are within a tolerance range of a specified location. The moving platform may be an unmanned aerial vehicle (UAV) or a piloted aircraft. For example, and in the case of a UAV, the tolerance could be less than 5 m using non-differentially-corrected global navigation satellite system (GNSS) positioning, or less than 0.5 m using real-time kinematic GNSS positioning.

In some embodiments, a size of the time-1 tile is based on at least one of: a complexity of a processor core implementing the recursive neural network, a size of the change in the infrastructure asset, or a resolution of the multitemporal image sets.

In some embodiments, the recursive neural network is trained using a first plurality of time-1 and time-n tile pairs and a second plurality of time-1 and time-n tile pairs, with each time-n tile of the first plurality of time-1 and time n tile pairs including real or simulated damage, and each time-1 tile and time-n tile of the second plurality of time-1 and time-n tile pairs including no damage.

In some embodiments, the infrastructure asset includes an electric utility tower or pole, a building, a road, a bridge, a power plant, a transformer, a sub-station, a dam, a solar array, a wind-power tower, a silo, oil and gas pumping equipment, oil and gas transfer equipment including a station and a pipeline, a water purification plant, a chemical processing plant, mining equipment, an aircraft, and rail infrastructure.

The disclosed embodiments further provide a method including detecting damage to a structure by obtaining multitemporal images using a UAV or piloted aircraft having an image capture sensor, a processor, a memory, and programming instructions to effect capture and transmission of the multitemporal images to a damage detection module, the damage detection module including an RSI dataset connected to an RNN architecture, the RNN having image training for detection of structural damage, wherein the multitemporal images are co-registered with images in the RSI dataset, and an anomaly detection module compares the multitemporal images co-registered with images in the RSI dataset to detect damage with an accuracy range of 93.0% to 97.6%, wherein the structure is selected from an electric utility tower or pole, a building, a road, and a bridge, a power plant, a transformer, a sub-station, a dam, a solar array, a wind-power tower, a silo, oil and gas pumping equipment, oil and gas transfer equipment including a station and pipelines, a water purification plant, a chemical processing plant, mining equipment, an aircraft, or rail infrastructure.

The disclosed embodiments further provide an unmanned aerial vehicle or piloted aircraft including an image capture sensor configured to produce output while the unmanned aerial vehicle navigates about a structure according to a flight plan; and a damage detection module configured to obtain multitemporal images using the UAV from the image capture sensor, the UAV having a processor, a memory, and programming instructions saved to the memory that, when executed by the processor is able to effect capture and transmission of the multitemporal images to the damage detection module, the damage detection module including an RSI dataset connected to an RNN architecture, the RNN having image training for detection and identification of structural damage, wherein the multitemporal images are co-registered with images in the RSI dataset, and an anomaly detection module compares the multitemporal images co-registered with images in the RSI dataset to detect damage with an accuracy range of 93.0% to 97.6%, wherein the structure is selected from an electric utility tower or pole, a building, a road, and a bridge, a power plant, a transformer, a sub-station, a dam, a solar array, a wind-power tower, a silo, oil and gas pumping equipment, oil and gas transfer equipment including a station and pipelines, a water purification plant, a chemical processing plant, mining equipment, an aircraft, or rail infrastructure.

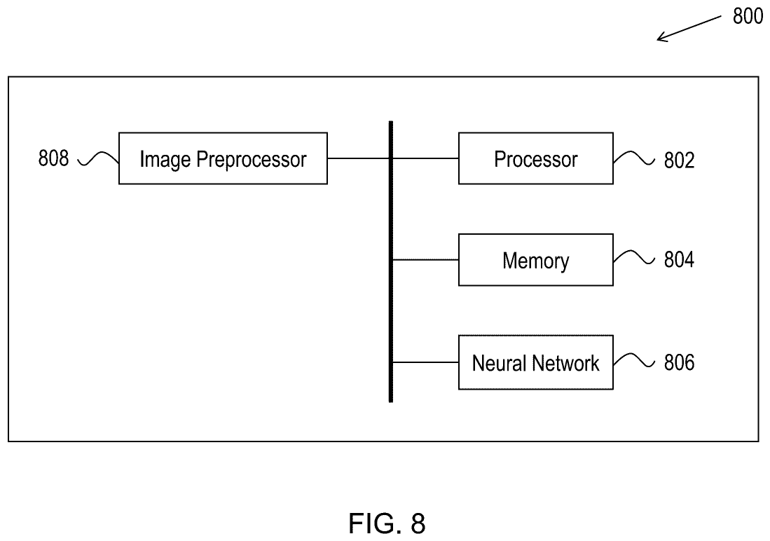

FIG. 8 shows an example of a hardware platform 800 that can be used to implement some of the techniques described in the present document. For example, the hardware platform 800 may implement method 700, or may implement the various modules and algorithms described herein. The hardware platform 800 may include a processor 802 that can execute code to implement a method. The hardware platform 800 may include a memory 804 that may be used to store processor-executable code and/or store data. The hardware platform 800 may further include a neural network (e.g., RNN 200 shown in FIG. 2) 806 and an image preprocessor 808, which can communicate with the processor 802. In some embodiments, the processor 802 may include one or more processors implementing the neural network 806 and the image preprocessor 808. The processor 802 may be configured to implement image co-registration and/or change detection algorithms. In some embodiments, the processor 802 (and/or the neural network 806 and the image preprocessor 808) are located on the UAV that is used to capture the images of the infrastructure asset. In other embodiments, the UAV captures images are transmits them (either wirelessly in near real-time, or via a wired connection in a post-flight data collection phase) to a remote location for processing. In some embodiments, the memory 804 may include multiple memories, some of which are exclusively used by the processor 802 when implementing the image co-registration and/or change detection algorithms.

The described features can be implemented to further provide one or more of the following technical solutions:

1. A method for identifying a change in an infrastructure asset, including: performing an image co-registration operation to spatially align multitemporal image sets including different image sets of digital images of the infrastructure asset captured under identical or nearly identical conditions and sequentially in time with previously captured reference images of the infrastructure asset to generate different registered image sets; pairing two registered image sets corresponding to images captured at two different times to form a registered image pair set; segmenting each image of each image pair of the registered image pair set to generate a plurality of paired tiles; and performing, using a recursive neural network, a change detection operation on each of the plurality of paired tiles to detect a change in the infrastructure asset between two paired tiles for images captured at different times, respectively, wherein the recursive neural network includes: at least one convolution network layer including an input configured to receive the plurality of paired tiles, at least one recurrent network layer including an input coupled to an output of the at least one convolution network layer, a plurality of fully-connected layers including an input coupled to an output of the at least one recurrent network layer, and an output classifier including an input coupled to an output of the plurality of fully-connected layers and an output configured to generate a result of the change detection operation.

2. The method of solution 1, wherein the multitemporal image sets comprising different image sets of digital images of the infrastructure asset captured under identical or nearly identical conditions and sequentially in time are captured by using one or more image sensors on a moving platform, wherein a first location of the moving platform when capturing a first image set and a second location of the moving platform when capturing a second image set are within a tolerance range of a specified location.

3. The method of solution 2, wherein the previously captured reference images of the infrastructure asset are generated using the one or more image sensors on the moving platform.

4. The method of solution 2, wherein the moving platform is an unmanned aerial vehicle (UAV) or a crewed aircraft.

5. The method of any of solutions 1 to 4, wherein the at least one convolution network layer includes a plurality of time-distributed convolution filters and a pooling layer.

6. The method of any of solutions 1 to 5, wherein the at least one recurrent network layer includes a plurality of long short-term memory (LSTM) recurrent network layers.

7. The method of any of solutions 1 to 6, wherein each of the plurality of fully-connected layers uses a rectified linear unit (ReLU) activation function.

8. The method of any of solutions 1 to 7, wherein the output classifier uses a sigmoid activation function.

9. The method of any of solutions 1 to 8, wherein the recursive neural network is trained on a plurality of time-1 and time-n image pairs.

10. The method of any of solutions 1 to 9, wherein a size of the time-1 tile is based on at least one of: a complexity of a processor core implementing the recursive neural network, a size of the change in the infrastructure asset, or a resolution of the multitemporal image sets.

11. A system for identifying change in an infrastructure asset, including: an unmanned aerial vehicle (UAV) including one or more image sensors configured to capture multitemporal image sets including a time-1 image set and a time-n image set that is sequentially later in time than the time-1 image set, wherein each of the time-1 image set and the time-n image set includes a sequence of digital images of the infrastructure asset; and one or more processors configured to: perform an image co-registration operation between the multitemporal image sets and images in a repeat station imaging dataset to generate a registered image pair set including a registered time-1 image set and a registered time-n image set; segment each image of each image pair of the registered image pair set to generate a plurality of paired tiles; and perform, using a recursive neural network, a change detection operation on each of the plurality of paired tiles to detect a change in the infrastructure asset between a time-1 tile and a time-n tile, wherein the recursive neural network includes: at least one convolution network layer including an input configured to receive the plurality of paired tiles, at least one recurrent network layer including an input coupled to an output of the at least one convolution network layer, a plurality of fully-connected layers including an input coupled to an output of the at least one recurrent network layer, and an output classifier including an input coupled to an output of the plurality of fully-connected layers and an output configured to generate a result of the change detection operation.

12. The system of solution 11, wherein the recursive neural network is trained using a first plurality of time-1 and time-n tile pairs and a second plurality of time-1 and time-n tile pairs.

13. The system of solution 12, wherein each time-n tile of the first plurality of time-1 and time n tile pairs includes real or simulated damage, and wherein each time-1 tile and time-n tile of the second plurality of time-1 and time-n tile pairs includes no damage.

14. The system of any of solutions 11 to 13, wherein a size of the time-1 tile is based on at least one of: a computational capability of the one or more processors, a size of the change in the infrastructure asset, or a resolution of the multitemporal image sets.

15. The system of any of solutions 11 to 14, wherein the infrastructure asset includes an electric utility tower or pole, a building, a road, a bridge, a power plant, a transformer, a sub-station, a dam, a solar array, a wind-power tower, a silo, oil and gas pumping equipment, oil and gas transfer equipment including a station and a pipeline, a water purification plant, a chemical processing plant, mining equipment, an aircraft, and rail infrastructure.

16. A system for identifying change in an infrastructure asset, including: one or more processors; and one or more memories storing instructions that, when executed, cause the one or more processors to: receive a multitemporal image pair set including a time-1 image set and a time-n image set that is sequentially later in time than the time-1 image set, wherein each of the time-1 image set and the time-n image set includes a sequence of digital images of the infrastructure asset; segment each image of time-1 image set and the time-n image set to generate a plurality of paired tiles; and perform, using a recursive neural network, a change detection operation on each of the plurality of paired tiles to detect a change in the infrastructure asset between a time-1 tile and a time-n tile, wherein the recursive neural network includes: at least one convolution network layer including an input configured to receive the plurality of paired tiles, a plurality of time-distributed convolution filters, a pooling layer, and an output from the pooling layer, at least one recurrent network layer including an input coupled to the output from the pooling layer, a plurality of long short-term memory (LSTM) recurrent network layers, and an output from a last LSTM recurrent network layer, a plurality of fully-connected layers including an input coupled to the output of the last LSTM recurrent network layer and an output from a last fully-connected layer, each fully-connected layer using a rectified linear unit (ReLU) activation function, and an output classifier including an input coupled to the output of the last fully-connected layer and an output configured to generate a result of the change detection operation, the output classifier using a sigmoid activation function.

17. The system of solution 16, wherein the instructions further cause the one or more processors to perform, prior to segmenting, an image co-registration operation between the multitemporal image pair set and images in a repeat station imaging dataset.

18. The system of solution 16 or 17, wherein a size of the time-1 tile is based on a computational capability of the one or more processors or a capacity of the one or more memories.

19. The system of any of solutions 16 to 18, wherein a size of the time-1 tile is based on a size of the change in the infrastructure asset.

20. The system of any of solutions 16 to 18, wherein a size of the time-1 tile is based on a resolution of the multitemporal image set.

21. An apparatus including a processor that is configured to implement a method recited in one or more of solutions 1 to 10.

22. A non-transitory computer readable program storage medium having code stored thereon, the code, when executed by a processor, causing the processor to implement a method recited in one or more of solutions 1 to 10.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and devices can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, these are optional. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A method for identifying a change in an infrastructure asset, comprising:
performing an image co-registration operation to spatially align multitemporal image sets comprising different image sets of digital images of the infrastructure asset captured under identical or nearly identical conditions and sequentially in time with previously captured reference images of the infrastructure asset to generate different registered image sets;
pairing two registered image sets corresponding to images captured at two different times to form a registered image pair set;
segmenting each image of each image pair of the registered image pair set to generate a plurality of paired tiles; and
performing, using a recursive neural network, a change detection operation on each of the plurality of paired tiles to detect a change in the infrastructure asset between two paired tiles for images captured at different times, respectively,
wherein the recursive neural network includes:
at least one convolution network layer comprising an input configured to receive the plurality of paired tiles,
at least one recurrent network layer comprising an input coupled to an output of the at least one convolution network layer,
a plurality of fully-connected layers comprising an input coupled to an output of the at least one recurrent network layer, and
an output classifier comprising an input coupled to an output of the plurality of fully-connected layers and an output configured to generate a result of the change detection operation.

2. The method of claim 1, wherein the multitemporal image sets comprising different image sets of digital images of the infrastructure asset captured under identical or nearly identical conditions and sequentially in time are captured by using one or more image sensors on a moving platform, wherein a first location of the moving platform when capturing a first image set and a second location of the moving platform when capturing a second image set are within a tolerance range of a specified location.

3. The method of claim 2, wherein the previously captured reference images of the infrastructure asset are generated using the one or more image sensors on the moving platform.

4. The method of claim 2, wherein the moving platform is an unmanned aerial vehicle (UAV) or a crewed aircraft.

5. The method of claim 1, wherein the at least one convolution network layer includes a plurality of time-distributed convolution filters and a pooling layer.

6. The method of claim 1, wherein the at least one recurrent network layer includes a plurality of long short-term memory (LSTM) recurrent network layers.

7. The method of claim 1, wherein each of the plurality of fully-connected layers uses a rectified linear unit (ReLU) activation function.

8. The method of claim 1, wherein the output classifier uses a sigmoid activation function.

9. The method of claim 1, wherein the recursive neural network is trained on a plurality of time-1 and time-n image pairs.

10. The method of claim 1, wherein a size of a time-1 tile is based on at least one of: a complexity of a processor core implementing the recursive neural network, a size of the change in the infrastructure asset, or a resolution of the multitemporal image sets.

11. A system for identifying change in an infrastructure asset, comprising:
an unmanned aerial vehicle (UAV) comprising one or more image sensors configured to capture multitemporal image sets comprising a time-1 image set and a time-n image set that is sequentially later in time than the time-1 image set, wherein each of the time-1 image set and the time-n image set includes a sequence of digital images of the infrastructure asset; and
one or more processors configured to:
perform an image co-registration operation between the multitemporal image sets and images in a repeat station imaging dataset to generate a registered image pair set comprising a registered time-1 image set and a registered time-n image set;
segment each image of each image pair of the registered image pair set to generate a plurality of paired tiles; and
perform, using a recursive neural network, a change detection operation on each of the plurality of paired tiles to detect a change in the infrastructure asset between a time-1 tile and a time-n tile,
wherein the recursive neural network includes:
at least one convolution network layer comprising an input configured to receive the plurality of paired tiles,
at least one recurrent network layer comprising an input coupled to an output of the at least one convolution network layer,
a plurality of fully-connected layers comprising an input coupled to an output of the at least one recurrent network layer, and
an output classifier comprising an input coupled to an output of the plurality of fully-connected layers and an output configured to generate a result of the change detection operation.

12. The system of claim 11, wherein the recursive neural network is trained using a first plurality of time-1 and time-n tile pairs and a second plurality of time-1 and time-n tile pairs.

13. The system of claim 12, wherein each time-n tile of the first plurality of time-1 and time-n tile pairs includes real or simulated damage, and wherein each time-1 tile and time-n tile of the second plurality of time-1 and time-n tile pairs includes no damage.

14. The system of claim 11, wherein a size of the time-1 tile is based on at least one of: a computational capability of the one or more processors, a size of the change in the infrastructure asset, or a resolution of the multitemporal image sets.

15. The system of claim 11, wherein the infrastructure asset includes an electric utility tower or pole, a building, a road, a bridge, a power plant, a transformer, a sub-station, a dam, a solar array, a wind-power tower, a silo, oil and gas pumping equipment, oil and gas transfer equipment including a station and a pipeline, a water purification plant, a chemical processing plant, mining equipment, an aircraft, and rail infrastructure.

16. A system for identifying change in an infrastructure asset, comprising:
one or more processors; and
one or more memories storing instructions that, when executed, cause the one or more processors to:
receive a multitemporal image pair set comprising a time-1 image set and a time-n image set that is sequentially later in time than the time-1 image set, wherein each of the time-1 image set and the time-n image set includes a sequence of digital images of the infrastructure asset;
segment each image of the time-1 image set and the time-n image set to generate a plurality of paired tiles; and
perform, using a recursive neural network, a change detection operation on each of the plurality of paired tiles to detect a change in the infrastructure asset between a time-1 tile and a time-n tile,
wherein the recursive neural network includes:
at least one convolution network layer comprising an input configured to receive the plurality of paired tiles, a plurality of time-distributed convolution filters, a pooling layer, and an output from the pooling layer,
at least one recurrent network layer comprising an input coupled to the output from the pooling layer, a plurality of long short-term memory (LSTM) recurrent network layers, and an output from a last LSTM recurrent network layer,
a plurality of fully-connected layers comprising an input coupled to the output of the last LSTM recurrent network layer and an output from a last fully-connected layer, each fully-connected layer using a rectified linear unit (ReLU) activation function, and
an output classifier comprising an input coupled to the output of the last fully-connected layer and an output configured to generate a result of the change detection operation, the output classifier using a sigmoid activation function.

17. The system of claim 16, wherein the instructions further cause the one or more processors to perform, prior to segmenting, an image co-registration operation between the multitemporal image pair set and images in a repeat station imaging dataset.

18. The system of claim 16, wherein a size of the time-1 tile is based on a computational capability of the one or more processors or a capacity of the one or more memories.

19. The system of claim 16, wherein a size of the time-1 tile is based on a size of the change in the infrastructure asset.

20. The system of claim 16, wherein a size of the time-1 tile is based on a resolution of the multitemporal image pair set.

21-22. (canceled)
